(19) United States
(12) Patent Application Publication
(10) Pub. No.: US 2019/0206398 A1
(43) Pub. Date: Jul. 4, 2019

(54) INFORMATION CAPTURING DEVICE AND VOICE CONTROL METHOD

(71) Applicant: GETAC TECHNOLOGY CORPORATION, Hsinchu County (TW)

(72) Inventor: MIN-TAI CHEN, Taipei City (TW)

(21) Appl. No.: 16/151,254

(22) Filed: Oct. 3, 2018

Related U.S. Application Data
(60) Provisional application No. 62/613,010, filed on Jan. 2, 2018.

(51) Int. Cl. G10L 15/22; H04N 5/76

(52) U.S. Cl. CPC G10L 15/22; G10L 2015/225; G10L 2015/223; H04N 5/76

(57) ABSTRACT

A voice control method for an information capturing device includes: receiving a sound signal; performing voice recognition on the sound signal to obtain an actual voice content; confirming at least a command voice content according to the actual voice content; obtaining an operating command corresponding to the command voice content if the actual voice content corresponds to any the command voice content; and performing, in response to the operating command, an operation corresponding to the operating command.

### CROSS-REFERENCE TO RELATED APPLICATIONS

This application claims priority from U.S. Patent Application Ser. No. 62/613,010, filed on Jan. 2, 2018, the entire disclosure of which is hereby incorporated by reference.

### BACKGROUND OF THE INVENTION

### Field of the Invention

The present disclosure relates to technology of controlling information capturing devices and, more particularly, to an information capturing device and voice control technology related thereto.

### Description of the Prior Art

Police officers on duty have to record sounds and shoot videos in order to collect evidence and preserve the evidence. Hence, police officers on duty wear information capturing devices for capturing medium-related data, including images and sounds, from the surroundings, so as to facilitate policing. The medium-related data recorded by the information capturing devices is descriptive of real-time on-site conditions of an ongoing event with a view to fulfilling burdens of proof and clarifying liabilities later.

Users operate start switches of conventional portable information capturing devices in order to enable the portable information capturing devices to capture data related to the surroundings. However, in an emergency, a typical scenario is as follows: it is too late for the users to start capturing data by hand; or images and/or sounds related to a crucial situation have already vanished by the time the users start capturing data by hand. Furthermore, to get informed of operation-related status of the portable information capturing devices, such as remaining power level and/or capacity, the users have to operate function switches of the portable information capturing devices in order to enable the portable information capturing devices to display captured information in real time.

### SUMMARY OF THE INVENTION

In an embodiment of the present disclosure, a voice control method for an information capturing device, including the steps of: receiving a sound signal; performing voice recognition on the sound signal to obtain an actual voice content; confirming at least a command voice content according to the actual voice content; obtaining an operating command corresponding to the command voice content if the actual voice content corresponds to any the command voice content; and performing, in response to the operating command, an operation corresponding to the operating command.

In an embodiment of the present disclosure, an information capturing device includes a microphone, a voice recognition unit, a control unit and a video recording unit. The microphone receives a voice so as to create a sound signal corresponding to the voice. The voice recognition unit is coupled to the microphone to perform voice recognition on the sound signal so as to obtain an actual voice content. The video recording unit performs video recording to therefore capture an ambient datum. The control unit is coupled to the voice recognition unit and the video recording unit, obtains an operating command corresponding to the command voice content when the actual voice content corresponds to the command voice content, and performs, in response to the operating command, an operation corresponding to the operating command.

In conclusion, an information capturing device and a voice control method for the same in embodiments of the present disclosure entails performing voice recognition on a sound signal to therefore obtain an actual voice content and thus obtain a corresponding operating command, so as to perform, in response to the operating command, an operation corresponding to the operating command.

### BRIEF DESCRIPTION OF THE DRAWINGS

FIG. 1 is a block diagram of circuitry of an information capturing device according to an embodiment of the present disclosure;

FIG. 2 is a flowchart of a voice control method for the information capturing device according to an embodiment of the present disclosure;

FIG. 3 is a block diagram of circuitry of the information capturing device according to another embodiment of the present disclosure;

FIG. 4 is a flowchart of the voice control method for the information capturing device according to yet another embodiment of the present disclosure; and

FIG. 5 is a flowchart of the voice control method for the information capturing device according to still yet another embodiment of the present disclosure.

### DETAILED DESCRIPTION OF THE EMBODIMENTS

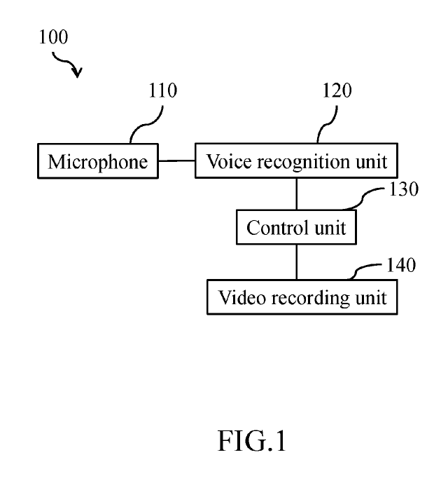

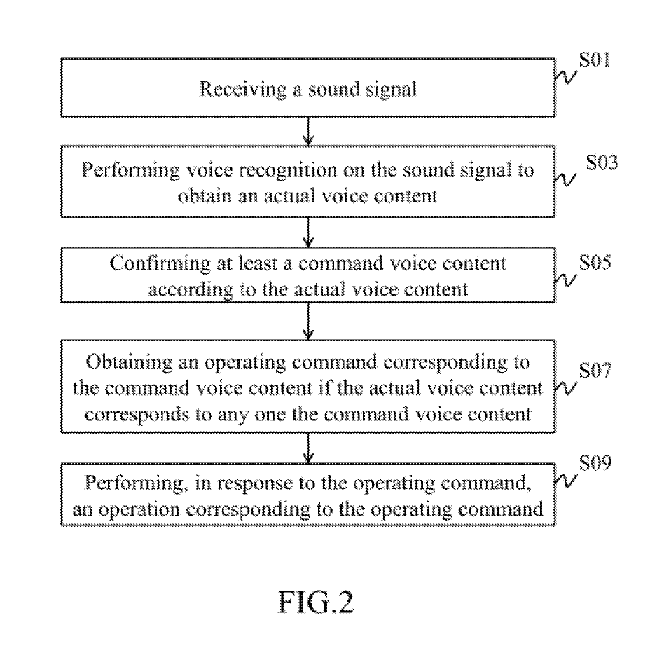

FIG. 1 is a block diagram of circuitry of an information capturing device according to an embodiment of the present disclosure. FIG. 2 is a flowchart of a voice control method for the information capturing device according to an embodiment of the present disclosure. Referring to FIG. 1 and FIG. 2, an information capturing device 100 includes a microphone 110, a voice recognition unit 120 and a control unit 130. The microphone 110 is coupled to the voice recognition unit 120. The voice recognition unit 120 is coupled to the control unit 130.

The microphone 110 receives a voice emitted from a user. The microphone 110 has a signal processing circuit (not shown). The signal processing circuit turns the voice (sound wave defined in physics) into a sound signal (digital signal).

The voice recognition unit 120 receives the sound signal (step S01) and performs voice recognition on the sound signal, so as to obtain an actual voice content (step S03). In an embodiment, in step S03, the voice recognition unit 120 analyzes the sound signal to therefore capture at least a feature of the sound signal, and then the voice recognition unit 120 discerns or compares the at least a feature of the sound signal with data of a voice model database to therefore select or determine a text content of the sound signal, so as to obtain an actual voice content which matches the at least a feature of the sound signal. In an exemplary embodiment, the voice model database contains voice signals in the form of word strings composed of one-word terms, multiple-word terms, and sentences. The voice recognition unit 120 analyzes and compares the at least a feature of the sound signal with a feature of each voice signal of the voice model database to therefore obtain an actual voice content.

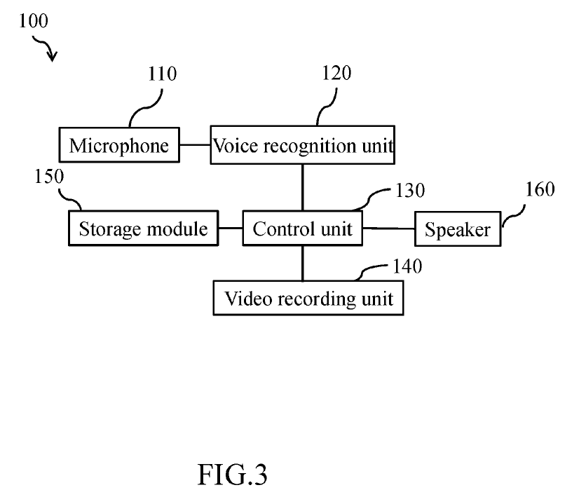

Afterward, the control unit 130 confirms at least a command voice content according to the actual voice content (step S05). In an exemplary embodiment, relationship between the actual voice content and the at least a command voice content is recorded in a lookup table (not shown) such that the control unit 130 searches the lookup table for at least one or a plurality of command voice contents and confirms the command voice content(s) corresponding to the actual voice content. In an embodiment aspect, the lookup table is stored in a storage module 150 of the information capturing device 100. Therefore, the information capturing device 100 further includes a storage module 150 (shown in FIG. 3). The storage module 150 is coupled to the control unit 130.

If the actual voice content corresponds to any one command voice content, that is, the actual voice content corresponds to the command voice content in whole or corresponds to the command voice content and another none-command voice content (such as an ambient sound content), the control unit 130 obtains an operating command corresponding to the command voice content according to the command voice content corresponding to the actual voice content (step S07). In an exemplary embodiment, an actual voice content corresponding to any one command voice content is identical to the command voice content in whole. In another exemplary embodiment, an actual voice content corresponding to any one command voice content is identical to the command voice content in part above a specific ratio. In yet another exemplary embodiment, an actual voice content corresponding to any one command voice content includes a content identical to the command voice content but different from the other contents (such as an ambient sound content) of the command voice content.

The control unit 130 performs, in response to an operating command, an operation corresponding to the operating command (step S09). In an exemplary embodiment, as soon as the corresponding command voice content in the lookup table is found, the control unit 130 fetches from the lookup table the operating command corresponding to the command voice content found and thus performs the corresponding operation.

In some embodiments, the control unit 130 is implemented as one or more processing components. The processing components are each a microprocessor, microcontroller, digital signal processor, central processing unit (CPU), programmable logic controller, state machine, or any analog and/or digital device based on the operating command and the operating signal, but the present disclosure is not limited thereto.

In some embodiments, the storage module 150 is implemented as one or more storage components. The storage components are each, for example, a memory or a register, but the present disclosure is not limited thereto.

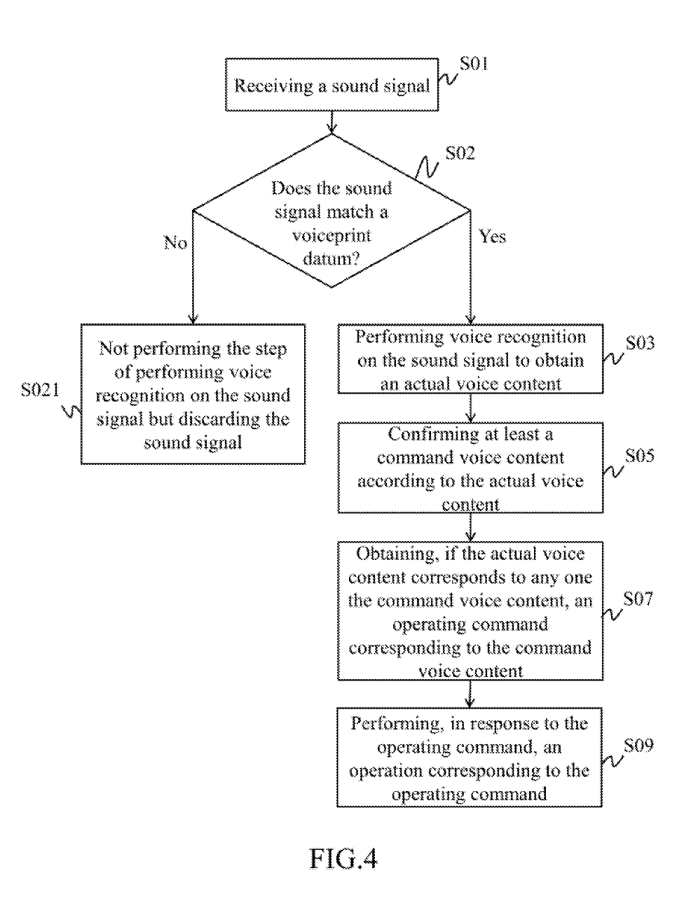

FIG. 4 is a flowchart of the voice control method for the information capturing device according to yet another embodiment of the present disclosure. As shown in FIG. 4, before step S03, the control unit 130 confirms the sound signal according to a voiceprint datum (step S02). Step S03 through step S09 are substantially identical to their aforesaid counterparts.

In an embodiment aspect, a user records each operating command beforehand with the microphone 110 in order to configure a predetermined sound spectrum correlated to the user and corresponding to each operating command. The voiceprint datum is the predetermined sound spectrum corresponding to each operating command. In another embodiment aspect, the voiceprint datum is recorded beforehand by one or more users and is the predetermined sound spectrum corresponding to each operating command. The voice recognition unit 120 analyzes the sound signal and thus creates an input sound spectrum such that the voice recognition unit 120 discerns or compares features of the input sound spectrum with features of a predetermined sound spectrum of the voiceprint datum to therefore perform identity authentication on a user, thereby identifying whether the sound is attributed to the user's voice.

If the sound signal matches the voiceprint datum, that is, if features of the input sound spectrum match features of a predetermined sound spectrum of the voiceprint datum, the control unit 130 performs voice recognition on the sound signal (step S03). Afterward, the information capturing device 100 proceeds to execute step S05 through step S09. In an embodiment aspect, the voiceprint datum is stored in the storage module 150 of the information capturing device 100. Therefore, the information capturing device 100 further includes a storage module 150 (shown in FIG. 3). The storage module 150 is coupled to the control unit 130.

If the sound signal does not match the voiceprint datum, that is, if features of the input sound spectrum do not match features of a predetermined sound spectrum of the voiceprint datum, the control unit 130 does not perform voice recognition on the sound signal but discards the sound signal (step S021).

The information capturing device 100 further includes a video recording unit 140. The video recording unit 140 is coupled to the control unit 130 and is capable of video recording. If operating command is a start recording command, the control unit 130 obtains the start recording command according to the command voice content corresponding to the actual voice content (step S07). Then, the control unit 130 controls, in response to the start recording command (i.e., in response to the operating command), the video recording unit 140 to perform video recording to therefore capture an ambient datum (step S09), that is, recording ambient images and/or sounds of the surroundings. The ambient datum is a medium-related file including ambient images and/or sounds, for example, a sound generated from a human being, animal or object in the surroundings (such as a horn sound made by a passing vehicle or a shout made by a pedestrian.) In some embodiments, the operating command is “start recording command,” “finish recording command,” “command of feeding back the number of hours video-recordable,” “command of saving a file and playing a prompt sound,” “command of feeding back remaining capacity” or “command of feeding back resolution,” but the present disclosure is not limited thereto.

In some embodiments, the video recording unit 140 is implemented as an image pickup lens and an image processing unit. In an exemplary embodiment, the image processing unit is an image signal processor (ISP). In another exemplary embodiment, the image processing unit and the control unit 130 is implemented by the same chip, but the present disclosure is not limited thereto.

In an exemplary embodiment illustrated by FIG. 1 and FIG. 2, if a user says “start camera recording” to the microphone 110, the microphone 110 receives a sound signal (step S01) and sends the received sound signal to the voice recognition unit 120. The voice recognition unit 120 performs voice recognition on the sound signal to obtain an actual voice content of “start camera recording” (step S03). The control unit 130 sequentially confirms the command voice contents recorded in the lookup table according to the actual voice contents of “start camera recording” obtained according to results of voice recognition (step S05), so as to identify the command voice content corresponding to the actual voice content. After identifying the command voice content, the control unit 130 fetches from the lookup table the operating command of “start recording command” corresponding to the command voice content (step S07). The control unit 130 controls, in response to the start recording command (i.e., in response to the operating command), the video recording unit 140 to perform video recording and thus capture an ambient datum (step S09). In an embodiment aspect, the control unit 130 further controls, in response to the start recording command (i.e., in response to the operating command), a light-emitting module (not shown) to emit light such that the user is aware that the video recording unit 140 is performing video recording.

In an exemplary embodiment, if the operating command is a finish recording command, the control unit 130 obtains the finish recording command according to the command voice content corresponding to the actual voice content (step S07), and then the control unit 130 controls, in response to the finish recording command (i.e., in response to the operating command), the video recording unit 140 to finish video recording so as to create an ambient datum (step S09). Therefore, in response to the finish recording command, the control unit 130 saves the ambient datum as a corresponding medium-related file. In an exemplary embodiment illustrated by FIG. 1 and FIG. 2, if the voice recognition unit 120 receives a sound signal (step S01) and performs voice recognition to obtain an actual voice content of “end camera recording” (step S03) and then the control unit 130 confirms the command voice content according to the actual voice content of “end camera recording” (step S05), the control unit 130 obtains the finish recording command (the operating command) corresponding to the command voice content according to the command voice content corresponding to the actual voice content of “end camera recording” (step S07). Afterward, the control unit 130 controls, in response to the finish recording command (i.e., in response to the operating command), the video recording unit 140 to finish video recording and thus create an ambient datum (step S09) before creating a medium-related file based on the ambient datum and then storing the medium-related file in the storage module 150. In an embodiment aspect, the control unit 130 further controls, in response to the finish recording command (i.e., in response to the operating command), a light-emitting module (not shown) to turn off such that the user is aware that the video recording unit 140 has already finished video recording and created the ambient datum.

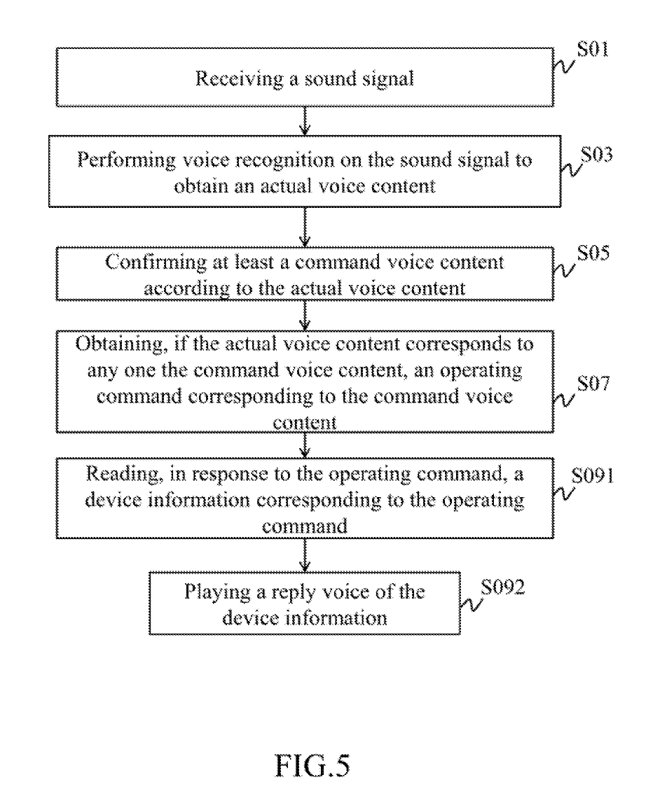

FIG. 5 is a flowchart of the voice control method for the information capturing device according to still yet another embodiment of the present disclosure. As shown in FIG. 3 and FIG. 5, in some embodiments of step S09, the control unit 130 reads, in response to the operating command, a device information corresponding to the operating command (step S091), and then the control unit 130 controls a speaker 160 to play a reply voice of the device information (step S092). Step S01 through step S07 are substantially identical to their aforesaid counterparts.

In an exemplary embodiment, if the voice recognition unit 120 receives a sound signal (step S01) and performs voice recognition to obtain an actual voice content of “battery life” (step S03) and then the control unit 130 confirms the command voice content according to the actual voice content of “battery life” (step S05), the control unit 130 obtains “command of feeding back the number of hours video-recordable” (operating command) corresponding to the command voice content according to the command voice content corresponding to the actual voice content of “battery life” (step S07). The control unit 130 reads, in response to “command of feeding back the number of hours video-recordable” (operating command) (i.e., in response to the operating command), the number of hours video-recordable from the device information (step S091). In an embodiment aspect, the control unit 130 counts the current number of video-recorded hours as well as determines the current number of video-recordable hours according to the remaining power level and/or capacity. Therefore, the information capturing device 100 further includes a timing module (not shown). The timing module is coupled to the control unit 130. Afterward, the control unit 130 controls a speaker 160 to play a reply voice of the number of hours video-recordable (step S092). In an embodiment aspect, the speaker 160 is built in a display unit (not shown), and the display unit is coupled to the control unit 130. The control unit 130 reads, in response to “command of feeding back the number of hours video-recordable” (operating command), the number of hours video-recordable from the device information (step S091). The control unit 130 controls a display panel of the display unit to display video frame information and the speaker 160 to play audio information (step S092).

In an exemplary embodiment, if the user says “event 1” to the microphone 110, the microphone 110 receives a sound signal (step S01) and sends the received sound signal to the voice recognition unit 120. The voice recognition unit 120 performs voice recognition on the sound signal so as to obtain an actual voice content of “event 1” (step S03). The control unit 130 sequentially confirms the command voice contents recorded in the lookup table according to the actual voice content of “event 1” obtained according to results of voice recognition (step S05), so as to identify the command voice content corresponding to the actual voice content. After identifying the command voice content, the control unit 130 fetches from the lookup table the operating command of “command of saving a file and playing a prompt sound” corresponding to the command voice content (step S07). In response to “command of saving a file and playing a prompt sound” (i.e., in response to the operating command), the control unit 130 saves the video file and plays a reply voice.

In an exemplary embodiment, if the user says “feeding back remaining capacity” to the microphone 110, the microphone 110 receives a sound signal (step S01) and sends the received sound signal to the voice recognition unit 120. The voice recognition unit 120 performs voice recognition on the sound signal to obtain an actual voice content of “feeding back remaining capacity” (step S03). The control unit 130 sequentially confirms the command voice contents recorded in the lookup table according to the actual voice contents of “feeding back remaining capacity” obtained according to results of voice recognition (step S05), so as to identify the command voice content corresponding to the actual voice content. After identifying the command voice content, the control unit 130 fetches from the lookup table the operating command of “feeding back remaining capacity” corresponding to the command voice content (step S07). In response to “command of reading remaining capacity and playing a prompt sound” (i.e., in response to the operating command), the control unit 130 reads the remaining capacity from the device information and plays a reply voice of the remaining capacity from the device information.

In an exemplary embodiment, if the user says “feeding back resolution” to the microphone 110, the microphone 110 receives a sound signal (step S01) and sends the received sound signal to the voice recognition unit 120. The voice recognition unit 120 performs voice recognition on the sound signal to obtain an actual voice content of “feeding back resolution” (step S03). The control unit 130 sequentially confirms the command voice contents recorded in the lookup table according to the actual voice content of “feeding back resolution” obtained according to results of voice recognition (step S05), so as to identify the command voice content corresponding to the actual voice content. After identifying the command voice content, the control unit 130 fetches from the lookup table the operating command of “command of feeding back resolution” corresponding to the command voice content (step S07). In response to “command of feeding back resolution and playing a prompt sound” (i.e., in response to the operating command), the control unit 130 reads resolution from the device information and plays a reply voice of resolution from the device information.

In some embodiments, the information capturing device 100 is a portable image pickup device, such as a wearable camera, a portable evidence-collecting camcorder, a mini camera, or a hidden voice recorder mounted on a hat or clothes. In some embodiments, the information capturing device 100 is a stationary image pickup device, such as a dashboard camera mounted on a vehicle.

In conclusion, an information capturing device and a voice control method for the same in embodiments of the present disclosure entails performing voice recognition on a sound signal to therefore obtain an actual voice content and thus obtain a corresponding operating command, so as to perform, in response to the operating command, an operation corresponding to the operating command.

Although the present disclosure is disclosed above by preferred embodiments, the preferred embodiments are not restrictive of the present disclosure. Changes and modifications made by persons skilled in the art to the preferred embodiments without departing from the spirit of the present disclosure must be deemed falling within the scope of the present disclosure. Accordingly, the legal protection for the present disclosure should be defined by the appended claims.

What is claimed is:

1. A voice control method for an information capturing device, comprising the steps of:
receiving a sound signal;
performing voice recognition on the sound signal to obtain an actual voice content;
confirming at least a command voice content according to the actual voice content;
obtaining an operating command corresponding to the command voice content if the actual voice content corresponds to any the command voice content; and
performing, in response to the operating command, an operation corresponding to the operating command.

2. The method of claim 1, wherein the step of performing, in response to the operating command, the operation corresponding to the operating command comprises the sub-steps of:
reading, in response to the operating command, a device information corresponding to the operating command; and
playing a reply voice of the device information.

3. The method of claim 1, wherein the operating command is a start recording command, and the step of performing, in response to the operating command, the operation corresponding to the operating command comprises the sub-step of controlling, in response to the start recording command, a video recording unit to perform video recording so as to capture an ambient datum.

4. The method of claim 3, wherein the operating command is a finish recording command, and the step of performing, in response to the operating command, the operation corresponding to the operating command comprises the sub-step of controlling, in response to the finish recording command, the video recording unit to finish video recording so as to create the ambient datum.

5. The method of claim 1, further comprising the steps of:
confirming the sound signal according to a voiceprint datum;
performing the voice recognition on the sound signal only if the sound signal matches the voiceprint datum; and
not performing the voice recognition on the sound signal but discarding the sound signal if the sound signal does not match the voiceprint datum.

6. An information capturing device, comprising:
a microphone for receiving a voice to create a sound signal corresponding to the received voice;
a voice recognition unit coupled to the microphone to perform voice recognition on the sound signal so as to obtain an actual voice content;
a video recording unit for performing video recording so as to capture an ambient datum; and
a control unit coupled to the voice recognition unit and the video recording unit to obtain an operating command corresponding to the command voice content when the actual voice content corresponds to a command voice content and perform, in response to the operating command, an operation corresponding to the operating command.

7. The information capturing device of claim 6, further comprising a speaker, wherein, during the operation performed in response to the operating command and corresponding to the operating command, the control unit reads, in response to the operating command, a device information corresponding to the operating command, and the speaker plays a reply voice of the device information.

8. The information capturing device of claim 6, wherein the operating command is a start recording command, and, during the operation performed in response to the operating command and corresponding to the operating command, the control unit controls, in response to the start recording command, the video recording unit to perform video recording so as to capture the ambient datum.

9. The information capturing device of claim 8, wherein the operating command is a finish recording command, and, during the operation performed in response to the operating command and corresponding to the operating command, the control unit controls, in response to the finish recording command, the video recording unit to finish video recording so as to create the ambient datum.

10. The information capturing device of claim 6, wherein the control unit confirms the sound signal according to a voiceprint datum, performs the voice recognition on the sound signal only if the sound signal matches the voiceprint datum, and does not perform the voice recognition on the sound signal but discards the sound signal if the sound signal does not match the voiceprint datum.
